(19) United States
(12) Patent Application Publication
(10) Pub. No.: US 2026/0025301 A1
(43) Pub. Date: Jan. 22, 2026

(54) RADIO DEVICE

(71) Applicant: Nokia Solutions and Networks Oy, Espoo (FI)

(72) Inventors: Selahattin GOKCELI, Espoo (FI); Dani Johannes KORPI, Espoo (FI); Mikko Aleksi UUSITALO, Espoo (FI)

(21) Appl. No.: 18/995,548

(22) PCT Filed: Jul. 18, 2022
(86) PCT No.: PCT/EP2022/069989

§ 371 Date: Jan. 16, 2025

(51) Int. Cl. H04L 27/26

(52) U.S. Cl. CPC H04L 27/2623

(57) ABSTRACT

According to an example embodiment, a radio device comprises at least one processor and at least one memory including computer program code. The at least one memory and the computer program code may be configured to, with the at least one processor, cause the radio device to: obtain a plurality of symbols; generate a symbol vector for each symbol in the plurality of symbols comprising the symbol and at least symbols contiguous to the symbol in the plurality of symbols; generate a coefficient vector for each symbol in the plurality of symbols comprising corresponding Fourier coefficients of the symbol vector of the symbol; compute a peak value for each symbol in the plurality of symbols based on the symbol vector of the symbol and the coefficient vector of the symbol; compute a distortion signal based at least on the peak values; and sum the distortion signal and the plurality of symbols, producing a sum signal.

### TECHNICAL FIELD

The present application generally relates to the field of wireless communications. In particular, the present application relates to a radio device, and related methods and computer programs.

### BACKGROUND

High carrier frequencies are quite important for, for example, next-generation wireless networks considering the resource scarcity issue and the benefits that these frequency ranges can offer such as higher capacity and data rate. The current 3GPP standardization supports carrier frequencies up to 52.6 GHz. Yet, frequencies above this level are also studied by 3GPP RAN and it is expected that these will also be integral part of the future 6G specifications. Some of the potential problems of such high frequencies are higher path loss and hardware problems related to radio frequency (RF) components such as power amplifiers (PAS).

### SUMMARY

The scope of protection sought for various example embodiments is set out by the independent claims. The example embodiments and features, if any, described in this specification that do not fall under the scope of the independent claims are to be interpreted as examples useful for understanding various example embodiments.

An example embodiment of a radio device comprises at least one processor and at least one memory comprising computer program code. The at least one memory and the computer program code are configured to, with the at least one processor, cause the radio device to: obtain a plurality of symbols; generate a symbol vector for each symbol in the plurality of symbols comprising the symbol and at least symbols contiguous to the symbol in the plurality of symbols; generate a coefficient vector for each symbol in the plurality of symbols comprising corresponding Fourier coefficients of the symbol vector of the symbol; compute a peak value for each symbol in the plurality of symbols based on the symbol vector of the symbol and the coefficient vector of the symbol; compute a distortion signal based at least on the peak values; and sum the distortion signal and the plurality of symbols, producing a sum signal. The radio device can, for example, reduce peak-to-average power ratio of the sum signal.

An example embodiment of a radio device comprises means for performing: obtain a plurality of symbols; generate a symbol vector for each symbol in the plurality of symbols comprising the symbol and at least symbols contiguous to the symbol in the plurality of symbols; generate a coefficient vector for each symbol in the plurality of symbols comprising corresponding Fourier coefficients of the symbol vector of the symbol; compute a peak value for each symbol in the plurality of symbols based on the symbol vector of the symbol and the coefficient vector of the symbol; compute a distortion signal based at least on the peak values; and sum the distortion signal and the plurality of symbols, producing a sum signal.

In an example embodiment, alternatively or in addition to the above-described example embodiments, the at least one memory and the computer program code are further configured to, with the at least one processor, cause the radio device to compute the distortion signal based at least on the peak values by performing: compare a magnitude of each peak value to a threshold peak-to-average power ratio value, and in response to the peak value exceeding the threshold peak-to-average power ratio value, mark the corresponding symbol; and compute the distortion signal based on the marked symbols.

In an example embodiment, alternatively or in addition to the above-described example embodiments, the at least one memory and the computer program code are further configured to, with the at least one processor, cause the radio device to: perform a discrete Fourier transform pre-coding on the sum signal, producing a pre-coded signal; and perform an inverse discrete Fourier transform on the pre-coded signal, producing a discrete Fourier transform spread orthogonal frequency-division multiplexing signal. The radio device can, for example, reduce peak-to-average power ratio of the discrete Fourier transform spread orthogonal frequency-division multiplexing signal.

In an example embodiment, alternatively or in addition to the above-described example embodiments, the at least one memory and the computer program code are further configured to, with the at least one processor, cause the radio device to: compute a plurality of peak-cancelation signals using guard-band tones based on the peak values; and apply the plurality of peak-cancelation signals to the pre-coded signal before performing the inverse discrete Fourier transform on the pre-coded signal. The radio device can, for example, further reduce peak-to-average power ratio of the discrete Fourier transform spread orthogonal frequency-division multiplexing signal.

In an example embodiment, alternatively or in addition to the above-described example embodiments, the at least one memory and the computer program code are further configured to, with the at least one processor, cause the radio device to compute the peak value for each symbol in the plurality of symbols based on the symbol vector of the symbol and the coefficient vector of the symbol by performing: compute the peak value for each symbol as a dot product between the symbol vector of the symbol and the coefficient vector of the symbol; or compute the peak value for each symbol using a neural network by inputting the symbol vector of the symbol and the coefficient vector of the symbol into the neural network and obtaining the peak value as an output of the neural network. The radio device can, for example, efficiently compute the peak value for each symbol in the plurality of symbols.

In an example embodiment, alternatively or in addition to the above-described example embodiments, the neural network is configured to take a real part and an imaginary part of the symbol vector as separate inputs and a real part and an imaginary part the coefficient vector as separate inputs and output a real part and an imaginary part of the peak value as separate outputs. The radio device can, for example, utilize a neural network configured to be used with real values.

In an example embodiment, alternatively or in addition to the above-described example embodiments, the at least one memory and the computer program code are further configured to, with the at least one processor, cause the radio device to compute the distortion signal by finding, for each marked symbol, a quantization level that reduces the corresponding peak value. The radio device can, for example, efficiently compute the distortion signal.

In an example embodiment, alternatively or in addition to the above-described example embodiments, the at least one memory and the computer program code are further configured to, with the at least one processor, cause the radio device to find the quantization level for each marked symbol using a machine learning model. The radio device can, for example, efficiently find the quantization level for each marked symbol.

In an example embodiment, alternatively or in addition to the above-described example embodiments, the machine learning model comprises a neural network or a decision-tree based algorithm. The radio device can, for example, efficiently find the quantization level for each marked symbol using a neural network or a decision-tree based algorithm.

In an example embodiment, alternatively or in addition to the above-described example embodiments, the machine learning model is configured to take the symbol vector, the coefficient vector, and the peak value of the marked symbol as an input and output a part of the distortion signal corresponding to the marked symbol. The radio device can, for example, efficiently find the quantization level for each marked symbol using the machine learning model based on the symbol vector, the coefficient vector, and the peak value of the marked symbol.

In an example embodiment, alternatively or in addition to the above-described example embodiments, the at least one memory and the computer program code are further configured to, with the at least one processor, cause the radio device to: obtain an error vector magnitude threshold; and compute the distortion signal based on the marked symbols and the error vector magnitude threshold. The radio device can, for example, efficiently compute the distortion signal.

An example embodiment of a client device comprises the radio device according to any of the above-described example embodiments.

An example embodiment of a network node device comprises the radio device according to any of the above-described example embodiments.

An example embodiment of a method comprises: obtaining a plurality of symbols; generating a symbol vector for each symbol in the plurality of symbols comprising the symbol and at least symbols contiguous to the symbol in the plurality of symbols; generating a coefficient vector for each symbol in the plurality of symbols comprising corresponding Fourier coefficients of the symbol vector of the symbol; computing a peak value for each symbol in the plurality of symbols based on the symbol vector of the symbol and the coefficient vector of the symbol; computing a distortion signal based at least on the peak values; and summing the distortion signal and the plurality of symbols, producing a sum signal.

An example embodiment of a computer program product comprises program code configured to perform the method according to any of the above example embodiments, when the computer program product is executed on a computer.

### DESCRIPTION OF THE DRAWINGS

The accompanying drawings, which are included to provide a further understanding of the example embodiments and constitute a part of this specification, illustrate example embodiments and together with the description help to explain the principles of the example embodiments. In the drawings:

FIG. 1 illustrates an example embodiment of the subject matter described herein illustrating a radio device;

FIG. 2 illustrates comparison of power amplifier output power back-off according to a comparative example;

FIG. 3 illustrates maximum power reduction values according to a comparative example;

FIG. 4 illustrates the amplitude responses for term Z_{N×N}_{_{DFT}} by considering an index value of 200 according to a comparative example;

FIG. 5 illustrates the phase responses for term Z_{N×N}_{_{DFT}} by considering an index value of 200 according to a comparative example;

FIG. 6 illustrates the amplitude responses for term Z_{N×N}_{_{DFT}} by considering an index value of 1200 according to a comparative example;

FIG. 7 illustrates the phase responses for term Z_{N×N}_{_{DFT}} by considering an index value of 1200 according to a comparative example;

FIG. 8 illustrates a block diagram presentation of signal processing according to an example embodiment;

FIG. 9 illustrates a block diagram of a training procedure according to an example embodiment;

FIG. 10 illustrates parameters of a neural network configured for peak detection according to an example embodiment;

FIG. 11 illustrates parameters of a neural network configured for PAPR reduction according to an example embodiment;

FIG. 12 illustrates simulation results according to an example embodiment;

FIG. 13 illustrates simulation results according to another example embodiment;

FIG. 14 illustrates constellation points for the quantized distortion signal samples according to an example embodiment;

FIG. 15 illustrates simulation results according to an example embodiment;

FIG. 16 illustrates possible quantization points according to an example embodiment;

FIG. 17 illustrates simulation results according to an example embodiment;

FIG. 18 illustrates simulation results according to another example embodiment; and

FIG. 19 illustrates a flow chart representation of a method according to an example embodiment.

Like reference numerals are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present disclosure may be constructed or utilized. The description sets forth the functions of the example and the sequence of steps for constructing and operating the example. However, the same or equivalent functions and sequences may be accomplished by different example embodiments.

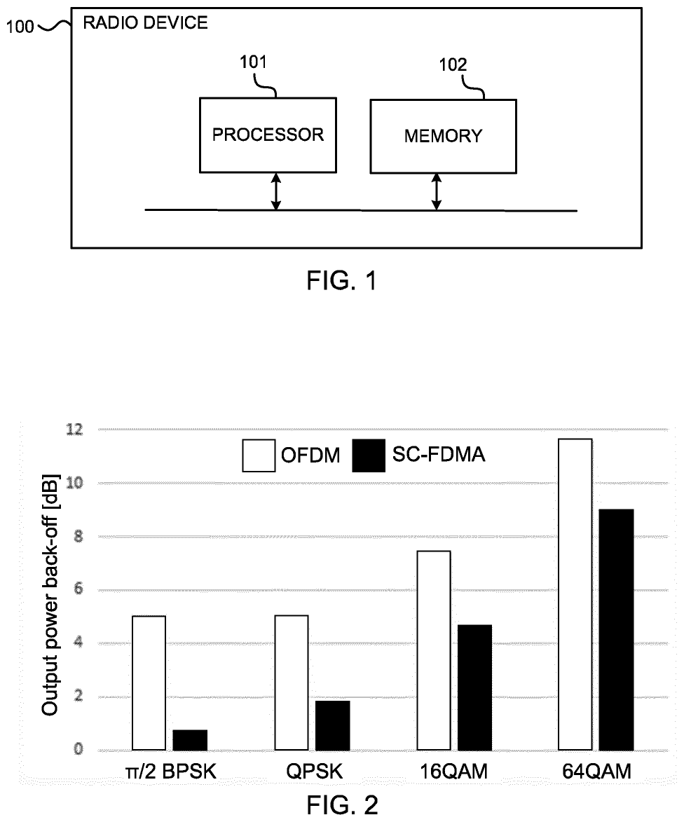

FIG. 1 is a block diagram of a radio device 100 configured in accordance with an example embodiment. The radio device 100 may comprise one or more processors 101 and one or more memories 102 that comprise computer program code. The radio device 100 may also comprise at least one antenna port, as well as other elements, such as an input/output module (not shown in FIG. 1), and/or a communication interface (not shown in FIG. 1).

According to an example embodiment, the at least one memory 102 and the computer program code are configured to, with the at least one processor 101, cause the radio device 100 to obtain a plurality of symbols.

Herein, symbols may also be referred to as data symbols or similar.

Each symbol in the plurality of symbols may comprise, for example, a quadrature amplitude modulation (QAM) symbol. For example, the plurality of symbols may comprise all the QAM symbols that are used to create a single discrete Fourier transform-spread orthogonal frequency-division multiplexing (DFT-s-OFDM) signal.

The plurality of symbols may comprise, for example, symbols to be transmitted via, for example, a wireless communication channel. The radio device 100 may, for example, be embodied in a radio transmitter or similar.

The plurality of symbols may be denoted by a vector d. An lth symbol in the plurality of symbols may be denoted by d[l].

The number of symbols in the plurality of symbols may be denoted by N_{DFT}.

The at least one memory 102 and the computer program code may be further configured to, with the at least one processor 101, cause the radio device 100 to generate a symbol vector for each symbol in the plurality of symbols comprising the symbol and at least symbols contiguous to the symbol in the plurality of symbols.

The symbol vector may comprise, for example, a subset/subvector of the symbols in the plurality of symbols.

A symbol vector corresponding to lth symbol in the plurality of symbols may be denoted by dₗ. The symbol vector dₗ may comprise the lth symbol and any number of symbols before and/or after the lth symbol in the plurality of symbols. For example, if the length of the symbol vector dₗ is L+1, the symbol vector may comprise the lth symbol, L/2 symbols before the lth symbol in the plurality of symbols and L/2 symbols after the lth symbol in the plurality of symbols. Thus, each symbol vector dₗ may comprise L+1 symbols out of the N_{DFT} symbols in the plurality of symbols.

The at least one memory 102 and the computer program code may be further configured to, with the at least one processor 101, cause the radio device 100 to generate a coefficient vector for each symbol in the plurality of symbols comprising corresponding Fourier coefficients of the symbol vector of the symbol.

The at least one memory 102 and the computer program code may be further configured to, with the at least one processor 101, cause the radio device 100 to compute a peak value for each symbol in the plurality of symbols based on the symbol vector of the symbol and the coefficient vector of the symbol.

The at least one memory 102 and the computer program code may be further configured to, with the at least one processor 101, cause the radio device 100 to compute a distortion signal based at least on the peak values.

The at least one memory 102 and the computer program code may be further configured to, with the at least one processor 101, cause the radio device 100 to sum the distortion signal and the plurality of symbols, producing a sum signal.

The sum signal may be used, by the radio device 100 or by some other device/components, to generate a DTF-s-OFDM signal to be transmitted.

Although the radio device 100 may be depicted to comprise only one processor 101, the radio device 100 may comprise more processors. In an example embodiment, the memory 102 is capable of storing instructions, such as an operating system and/or various applications.

Furthermore, the processor 101 may be capable of executing the stored instructions. In an example embodiment, the processor 101 may be embodied as a multicore processor, a single core processor, or a combination of one or more multi-core processors and one or more single core processors. For example, the processor 101 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 101 may be configured to execute hard-coded functionality. In an example embodiment, the processor 101 is embodied as an executor of software instructions, wherein the instructions may specifically configure the processor 101 to perform the algorithms and/or operations described herein when the instructions are executed.

The memory 102 may be embodied as one or more volatile memory devices, one or more non-volatile memory devices, and/or a combination of one or more volatile memory devices and non-volatile memory devices. For example, the memory 102 may be embodied as semiconductor memories (such as mask ROM, PROM (programmable ROM), EPROM (erasable PROM), flash ROM, RAM (random access memory), etc.).

According to an example embodiment, a client device comprises the radio device 100. The radio device 100 may be embodied in e.g. user equipment (UE), a mobile phone, a smartphone, a tablet computer, a smart watch, or any hand-held or portable device or any other apparatus, such as a vehicle, a robot, or a repeater.

According to an example embodiment, a network node device comprises the radio device 100. The radio device 100 may be embodied in, for example, a network node device, such as a base station (BS). The base station may comprise, for example, a gNB or any such device providing an air interface for client devices to connect to the wireless network via wireless transmissions.

When the radio device 100 is configured to implement some functionality, some component and/or components of the radio device 100, such as the at least one processor 101 and/or the memory 102, may be configured to implement this functionality. Furthermore, when the at least one processor 101 is configured to implement some functionality, this functionality may be implemented using program code comprised, for example, in the memory 102. For example, if the radio device 100 is configured to perform an operation, the at least one memory 102 and the computer program code can be configured to, with the at least one processor 101, cause the radio device 100 to perform that operation.

Some terminology used herein may follow the naming scheme of 4G or 5G technology in its current form. However, this terminology should not be considered limiting, and the terminology may change over time. Thus, the following discussion regarding any example embodiment may also apply to other technologies.

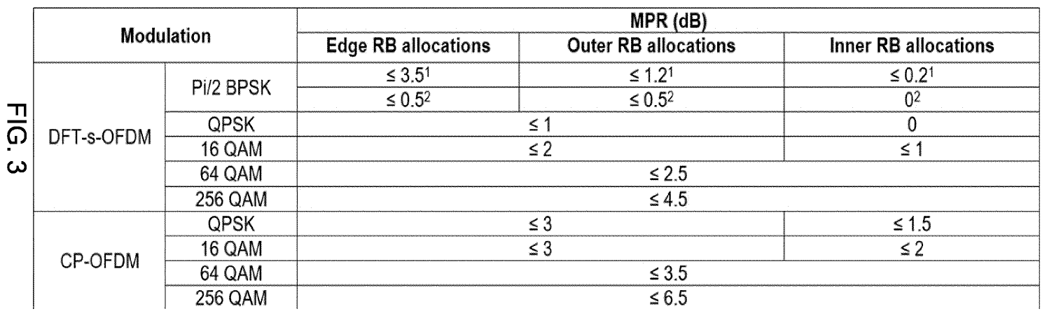

FIG. 2 illustrates comparison of power amplifier output power back-off according to a comparative example.

High carrier frequencies can be quite important for next-generation wireless networks considering the resource scarcity issue and the benefits that these frequency ranges offer such as higher capacity and data rate.

The current 3GPP standardization supports carrier frequencies up to 52.6 GHz. Yet, frequencies above this level are also studied by 3GPP RAN and it is expected that these will also be an integral part of the future 6G specifications.

For such frequency ranges, at least the following aspects should be considered: efficient transceiver design, including power efficiency and complexity, improvement of coverage to cope with extreme propagation loss, and inheriting physical layer channel design for below 52.6 GHz.

Some of the potential problems of such high frequencies are higher path loss and hardware problems related to RF components such as power amplifiers (PAS). Hence, higher PA efficiency and transmission power are important for good performance.

Moreover, the terahertz-frequency bands are expected to play a key role in 6G mainly due to the increase in the available spectrum and associated benefits. It is considered as one of the potential technologies that will make 6G different from the previous generations, because such frequency bands cannot be supported with the existing systems and a new design focusing on such bands is needed.

Low PA efficiency is one problem in high frequency communications, and phase noise can also significantly degrade the transmission quality. Cyclic-prefix orthogonal frequency division multiplexing (CP-OFDM), which is the main waveform of physical layer of 5G NR, is not an efficient option for high frequency communications as it has quite high peak to average power ratio (PAPR), which can harm the PA efficiency significantly.

Apart from single-carrier waveforms, DFT-s-OFDM waveform is also a good candidate for sub-THz communications due to its PAPR being lower than that of CP-OFDM. Also, DFT-s-OFDM can perform better than CP-OFDM under phase noise. Due to such advantages, DFT-s-OFDM is a promising main waveform for high frequency communications.

In the comparative example of FIG. 2, power backoff levels needed for satisfying the adjacent channel leakage ratio (ACLR) and modulation specific error vector magnitude (EVM) requirements are shown for different modulations and waveforms. Power backoff levels are illustrated for binary phase shift keying (BPSK), quadrature phase shift keying (QPSK), 16 QAM, and 64 QAM. It can be observed that DFT-s-OFDM has some advantages over CP-OFDM when lower order modulations are used. However, when it comes to higher order modulations, the advantages start to disappear and PAPR limits the performance of DFT-s-OFDM. This is quite problematic as higher order modulations are expected to be used in 5G and beyond more frequently. Therefore, it can be advantageous to improve the PAPR performance of DFT-s-OFDM waveform with higher order modulations to make it suitable for high-frequency communications.

FIG. 3 illustrates maximum power reduction values according to a comparative example.

Maximum power reduction (MPR) values in FR1 for UE are shown in the comparative example of FIG. 3. The MPR indicates transmit power backoff needed to support the utilized modulation. The values shown in the comparative example of FIG. 3 are determined by considering the requirements of ACLR, in-band emission (IBE), EVM and spectrum emission mask (SEM), so that maximum levels that satisfy all of these requirements are given. Increasing the modulation order can lead to higher MPR values, and therefore reduces the UE coverage. For example, when DFT-s-OFDM is considered, MPR is close to 0 for π/2 BPSK, but it increases up to 2.5 dB for 64 QAM. Hence, as stated, it can be beneficial to improve the PAPR performance of DFT-s-OFDM to maximize the transmission power levels at PA output.

The DFT-s-OFDM waveform processing starts with data symbol generation, where bits are converted to M-QAM or M-PSK symbols. Here, the data symbol at index l∈{0,1, . . . , N_{DFT}−1} is denoted as d[l]. Next, discrete Fourier transform (DFT) precoding is applied, and frequency-domain samples are obtained as

$$X [ k ] = \frac{1}{\sqrt{{N}_{DFT}}} {\sum }_{l = 0}^{{N}_{DFT} - 1} d [ l ] {e}^{\frac{- j 2 π kl}{{N}_{DFT}}} , \qquad ( 1 )$$

where k represents the frequency-domain subcarrier index with k∈{N/2, . . . , N/2−1}. After the zero padding, oversampled signal is converted to time-domain through inverse discrete Fourier transform (IDFT) as

$$x [ n ] = \frac{1}{\sqrt{N}} {\sum }_{k = - N / 2}^{N {/}_{2} - 1} X [ k ] {e}^{\frac{j 2 π kn}{N}} , \qquad ( 2 )$$

where n∈{0,1, . . . , N−1} denotes the time-domain sample index. An alternative representation of (2) can be written using (1) as

$$\begin{matrix}x [ n ] = \frac{1}{\sqrt{{N}_{DFT} N}} {\sum }_{l = 0}^{{N}_{DFT} - 1} d [ l ] {\sum }_{k = - {N}_{DFT} / 2}^{{N}_{DFT} / 2 - 1} {e}^{\frac{j 2 π kn - j 2 π kl}{N {N}_{DFT}}} \\ = \frac{1}{\sqrt{{N}_{DFT} N}} {\sum }_{l = 0}^{{N}_{DFT} - 1} d [ l ] g [ n - \frac{lN}{{N}_{DFT}} ] ,\end{matrix} \qquad ( 3 )$$

where the pulse function g[v] is given by

$$g [ v ] = {e}^{\frac{- j π}{N}} \frac{sin ( π {N}_{DFT} v / N )}{sin ( π v / N )} . \qquad ( 4 )$$

The characteristics of the pulses in (3) can be analysed to understand how data symbols d[l] are shaped by the DFT-s-OFDM processing. It can be shown that only small number of neighbouring symbols have major contribution to the large time-domain peaks, while others have quite negligible effect. This may be valid only when certain symbols in this symbol group have opposite phase values.

In order to confirm these claims, the following matrix notation can be considered. The time-domain DFT-s-OFDM waveform can be obtained in matrix-form as

$$x = {W}_{N \times {N}_{DFT}}^{- 1} {W}_{{N}_{DFT} \times {N}_{DFT}} {d}_{{N}_{DFT} \times 1} , \qquad ( 5 )$$

where

$${W}_{N \times {N}_{DFT}}^{- 1}$$

and W_{N}_{_{DFT}}_{×N}_{_{DFT}} represent the N×N_{DFT} IDFT and N_{DFT}×N_{DFT} DFT matrices, respectively. Moreover, d_{N}_{_{DFT}}_{×1} denotes the N_{DFT}×1 vector comprising the plurality of symbols. DFT pre-coded symbols are essentially allocated to N_{DFT} indices out of available N positions at the beginning of IDFT matrix, where N denotes the oversampled IDFT size.

The expression (5) can also be written as

$$x = {Z}_{N \times {N}_{DFT}} {d}_{{N}_{DFT} \times 1} , \qquad ( 6 )$$

where

$${Z}_{N \times {N}_{DFT}} = {W}_{N \times {N}_{DFT}}^{- 1} {W}_{{N}_{DFT} \times {N}_{DFT}} .$$

This representation is useful to understand why certain combinations of data symbols lead to large time-domain peaks. Magnitude and phases responses for this term show an interesting behaviour.

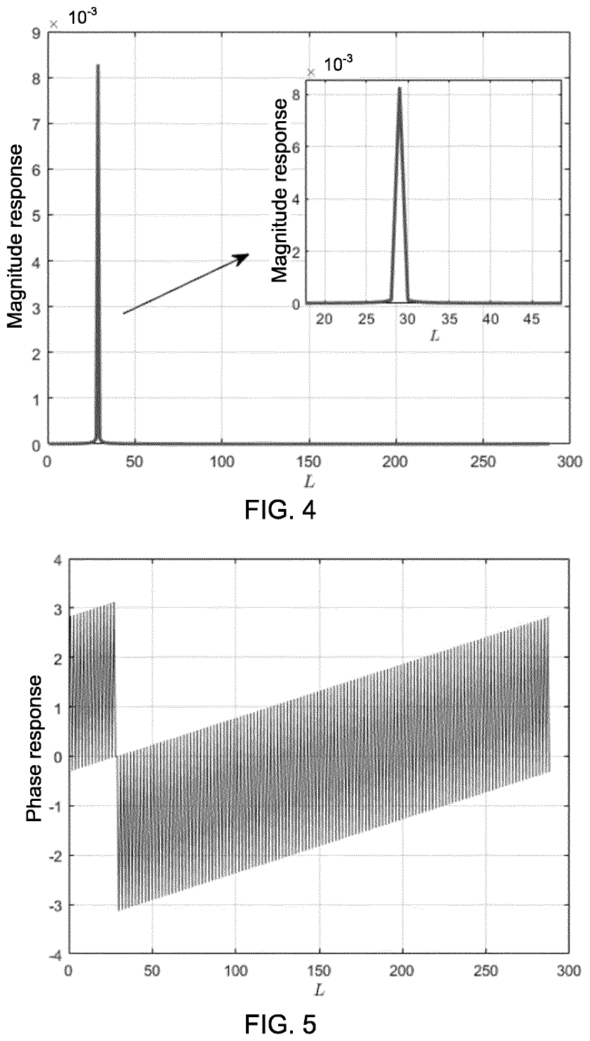

FIG. 4 illustrates the amplitude responses for term Z_{N×N}_{_{DFT}} by considering an index value of 200 according to a comparative example.

FIG. 5 illustrates the phase responses for term Z_{N×N}_{_{DFT}} by considering an index value of 200 according to a comparative example.

As seen from the comparative example of FIG. 4, the coefficient at index 29 has the highest amplitude value. This is why the data symbol at index 29 and neighbouring symbols have the highest contribution to sample at time-domain index 200, as they are multiplied with the coefficients that have quite a high amplitude values than the rest. Also, a drastic change occurs in the phase response at this index as can be seen from the comparative example of FIG. 5. Due to this, quite large time-domain peaks arise at time-domain index 200 especially when symbols at indices 28 and 29 are same outer constellation points, and the phase difference between symbols at indices 29 and 30 is around 180 degrees.

When a peak occurs at time-domain index n, the index of the data symbol that has highest contribution to this peak can be computed as

$$l = ⌊ \frac{( n + 0.5 ) {N}_{DFT}}{N} ⌉ + 1 , \qquad ( 7 )$$

where [ . . . ] denotes the rounding operation. The observations given for the comparative examples of FIG. 4 and FIG. 5 are in line with this derivation, as time index value of 200 leads to data symbol index of 29.

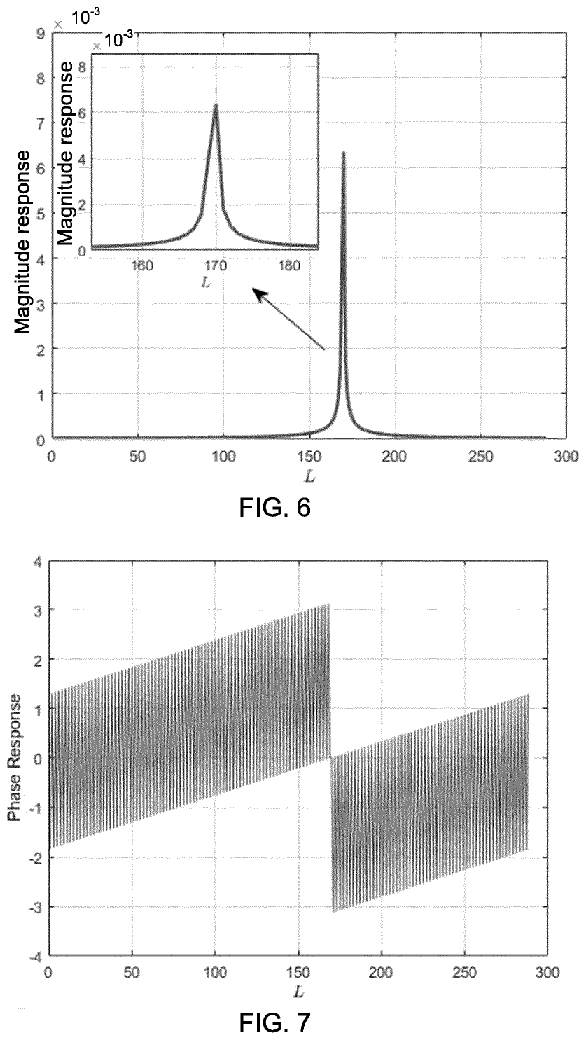

FIG. 6 illustrates the amplitude responses for term Z_{N×N}_{_{DFT}} by considering an index value of 1200 according to a comparative example.

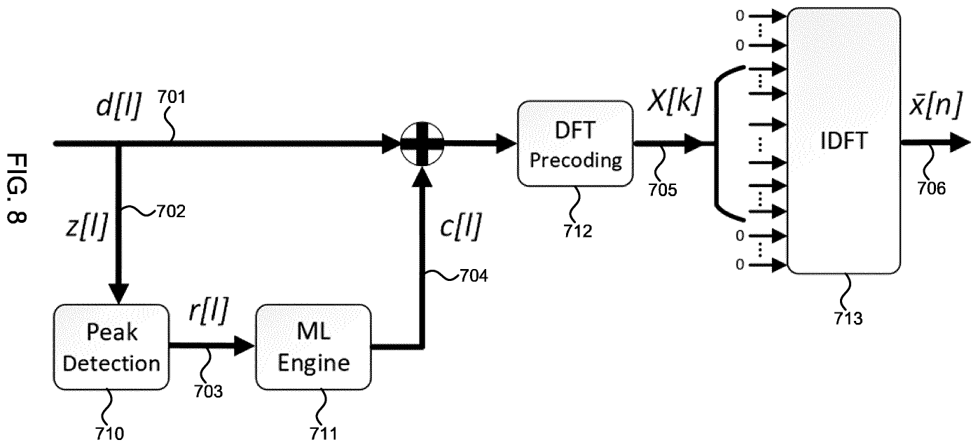

FIG. 7 illustrates the phase responses for term Z_{N×N}_{_{DFT}} by considering an index value of 1200 according to a comparative example.

Similar observations to those presented above for the comparative examples of FIG. 4 and FIG. 5 are also valid for the comparative examples of FIG. 6 and FIG. 7, and equation (7) gives data symbol index of 170 for the given time-domain index of 1200, where in FIG. 6, the highest amplitude value belongs to symbol at index 170.

Hence, it can be observed that there is a certain pattern that particular combinations of data symbols lead to large time-domain peaks. Such a pattern does not exist in CP-OFDM waveform as more or less all the data symbols have the same contribution to the time-domain peaks due to the characteristics of the IDFT. On the other hand, DFT precoding brings this interesting feature to the DFT-s-OFDM processing. The radio device 100 can exploit this feature to reduce the PAPR of the waveform in an efficient way.

Based the observations presented above, it could be assumed that two consecutive symbols on the outer constellation points and with opposite phases have the highest contribution to the resulting time-domain peaks. However, it is clear from the examples in FIGS. 4-7 that the symbol group with the highest impact cannot be restricted to two symbols, as some other symbols can also have a reasonable impact due to high-amplitude coefficients.

Such an assumption can be misleading and can lead to limited performance gains. On the other hand, peak-detection filter could be implemented by utilizing this feature and the characteristics of the terms given in (3) and (4). Such a peak-detection filter may be able to predict the large time-domain peaks quite accurately with a minor increase in complexity. However, this method also has some limitations, and these can be summarized as follows:
It is not a general method, as parameters of peak-detection filter may need to be tuned separately for each different bandwidth configuration case, as the impact changes depending on the bandwidth configuration case. Moreover, the peak-detection filter needs to be configured separately based on the modulation used, limiting the flexibility.
It would require multiple stages that are realized in a sequential way to isolate problematic symbols in an efficient way. From this point of view, this sequential approach improves the computational efficiency but it may not be suitable for the modern networks due to delay that it brings. It is probably desired from algorithm to be also suitable for parallel processing.
It needs to realize relatively long filters to detect the problematic symbols and there is a clear room for improvement of the computational complexity by reducing the filter length. This also changes depending on the bandwidth configuration and more general model would be desired.
Detection performance can be limited especially when short filters are utilized.

Due to these drawbacks, there is a need for more robust and efficient peak-detection procedure for better PAPR reduction performance with DFT-s-OFDM. An efficient peak-detection procedure is the first step for efficient PAPR reduction that can be applied to DFT-s-OFDM waveform. In general, time-domain PAPR reduction is not efficient because there is usually a need for transform back to frequency-domain in an iterative manner to tune the frequency-domain subcarriers in a way to prevent potential issues such degradation on data subcarriers or violation of emission limits and so on. Also, especially when oversampling is applied, time-domain processing is usually computationally expensive compared to alternative approaches. Therefore, realizing PAPR reduction already before creating the full time-domain waveform can be quite efficient and peak detection is a component of this processing.

The phases of the two problematic symbols that are claimed to be causing the time-domain peaks could be modified to reduce the PAPR. However, this approach can degrade the bit error rate (BER) significantly and can have a limited PAPR reduction performance. A more efficient variant could be used to control the increase in BER. Still, PAPR performance can be quite limited. Alternatively, a guard-band tone reservation (GTR) method could be used and could provide a reasonable PAPR reduction. However, this option can introduce possible processing latency due to multi-stage processing and there is still room for improvement in PAPR reduction performance. As it will be shown, the PAPR reduction of the radio device 100 is compatible with the GTR option, and both can be combined to further improve the PAPR gain.

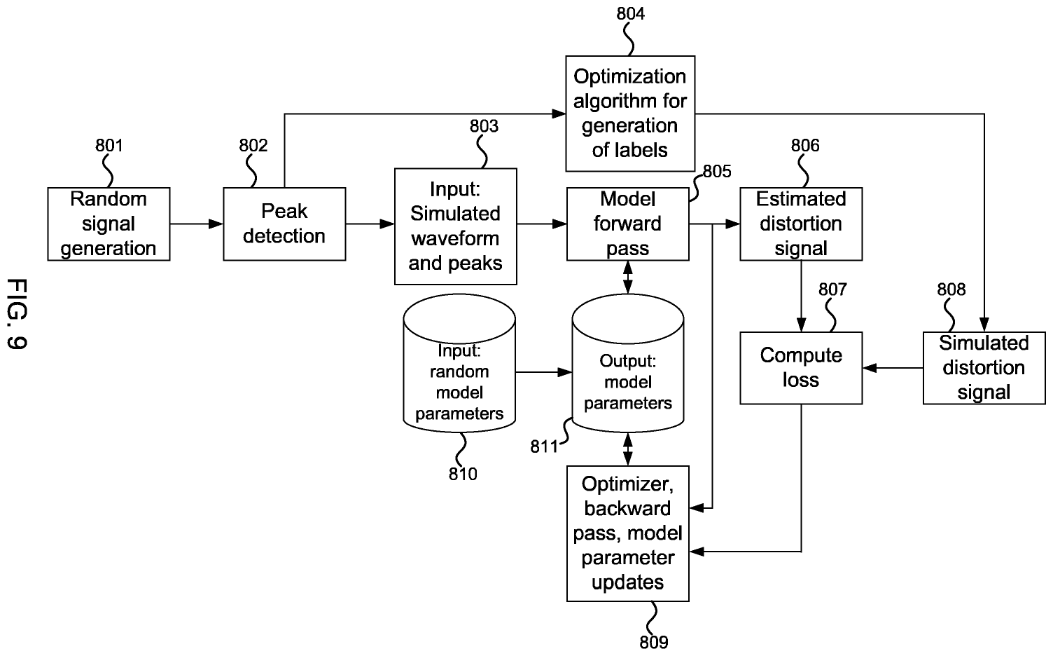

FIG. 8 illustrates a block diagram presentation of signal processing according to an example embodiment.

The radio device may implement two stages, which are peak-detection stage and a PAPR reduction stage. An example embodiment of these stages is illustrated in the block diagram shown in FIG. 8. Accordingly, the symbol vectors and the coefficient vectors are fed into the peak detection 710. Then, estimated peak values 703 are obtained and these are then fed to the machine learning (ML) Engine 711. The ML engine 711 computes the distortion signal 704 and this is then summed with the plurality of symbols 701.

Although the ML engine 711 is used for the PAPR reduction in the example embodiment of FIG. 8, PAPR reduction may also be implemented in some other manner.

Output of the summation can be fed to DFT Pre-coding 712 to realize the DFT precoding. In the end, IDFT operation 713 can be realized to create the PAPR reduced DFT-s-OFDM signal x̅ₙ 706.

In the peak detection phase 710, after the value of L has been determined, peak-detection can be realized by using, for example, the following terms.

For lth symbol in the plurality of symbols 701, the symbol vector can be created as

$${d}_{l} = \{ d [ mod ( l - L / 2 + 1 , {N}_{DFT} ) ] , d [ mod ( l - L / 2 + 2 , {N}_{DFT} ) ] … , d [ l ] , … , d [ mod ( l + L / 2 - 1 , {N}_{DFT} ) ] , d [ mod ( l + L / 2 , {N}_{DFT} ) ] \} . \qquad ( 8 )$$

Here, contiguous symbols can be assigned to the symbol vector dₗ, where central symbol corresponds to d[l]. The modulo operation mod(.)can be used to control the cases where some indices are less than 0 or greater than N_{DFT}−1. If this symbol set has the mentioned property, then these would lead to a large-peak at time-domain index n, which can be computed similar to (7) as

$$n == ⌊ \frac{( l - 0.5 ) N}{{N}_{DFT}} ⌉ + 1. \qquad ( 9 )$$

Similar to the data vector, associated DFT/IDFT coefficients can be collected into a coefficient vector 702 as

$${z}_{l} = \{ z [ mod ( l - L / 2 + 1 , {N}_{DFT} ) ] , z [ mod ( l - L / 2 + 2 , {N}_{DFT} ) ] … , z [ l ] , z [ mod ( l + L / 2 - 1 , {N}_{DFT} ) ] , z [ mod ( l + L / 2 , {N}_{DFT} ) ] \} , \qquad ( 10 )$$

where z[l] denotes the nth row vector of C_{N×N}_{_{DFT}}. This specific coefficient corresponds to the multiplication of DFT/IDFT coefficient pair that is multiplied with the data symbol d[l] when time-domain sample x[n] is generated.

According to an example embodiment, the at least one memory and the computer program code are further configured to, with the at least one processor, cause the radio device 100 to compute the peak value 703 for each symbol in the plurality of symbols 701 based on the symbol vector of the symbol and the coefficient vector of the symbol by performing: compute the peak value for each symbol as a dot product between the symbol vector of the symbol and the coefficient vector of the symbol or compute the peak value for each symbol using a neural network (NN) by inputting the symbol vector of the symbol and the coefficient vector of the symbol into the neural network and obtaining the peak value as an output of the neural network.

In some embodiments, the peak-detection can be implemented as

$${r}_{l} = {z}_{l} ∘ {d}_{l} , \qquad ( 11 )$$

where ○ denotes the dot product and rₗ is the peak value of symbol l. This approach is quite accurate. However, there are multiple complex multiplications for each data symbol.

According to an example embodiment, the neural network is configured to take a real part and an imaginary part of the symbol vector as separate inputs and a real part and an imaginary part the coefficient vector as separate inputs and output a real part and an imaginary part of the peak value as separate outputs.

In some embodiments, the peak-detection can be implemented as

$$[ real ( {r}_{l} ) , imag ( {r}_{l} ) ] = {f}_{peak} ( real ( {d}_{l} ) , imag ( {d}_{l} ) , real ( {z}_{l} ) , imag ( {z}_{l} ) ) , \qquad ( 12 )$$

where f(.) represents an algorithm that is configured to find the value for rₗ and, real(.) and imag(.) denote the real and imaginary parts of the given complex number.

The algorithm can be implemented using, for example, a relatively simple NN architecture designed for this problem. The complex numbers can be processed separately as real and imaginary parts as most of the conventional neural networks cannot process complex numbers. Through this simple mapping, the NN can find the peak value n 703. Such embodiments can circumvent the complexity drawback of the dot-product based embodiments. Such embodiments can have a reasonable complexity as the inference phase of NNs can require some multiplications. However, good prediction performance can be obtained by using an NN with, for example, a couple of dense layers, and with a suitable hardware, quite efficient processing can be achieved for such embodiments.

According to an example embodiment, the at least one memory and the computer program code are further configured to, with the at least one processor, cause the radio device to compute the distortion signal based at least on the peak values by performing: compare a magnitude of each peak value to a threshold peak-to-average power ratio value, and in response to the peak value exceeding the threshold peak-to-average power ratio value, mark the corresponding symbol, and compute the distortion signal based on the marked symbols.

The marked symbols can comprise symbols that cause large time-domain peaks. Such symbols may be referred to as problematic symbols or similar.

The magnitude of the peak value rₗ can be compared to a threshold corresponding to a desired PAPR limit. If the peak value exceeds the threshold, rₗ, the index of the symbol l, and/or the time-domain index n at which the symbol causes a peak can be stored for the PAPR reduction phase.

In the PAPR reduction phase, PAPR reduction can be performed by utilizing the information about peaks obtained in the peak detection phase.

The ML-based PAPR reduction 711 can operate on the data symbol group, the coefficients obtained from the term C_{N×N}_{_{DFT}}, and estimated peak values. These terms can be represented as:

For lₚth data symbol that leads to pth peak, the symbol vector is created as

$${d}_{{l}_{p}} = \{ d [ mod ( {l}_{p} - L / 2 + 1 , {N}_{DFT} ) ] , d [ mod ( {l}_{p} - L / 2 + 2 , {N}_{DFT} ) ] … , d [ {l}_{p} ] , d [ mod ( {l}_{p} + L / 2 - 1 , {N}_{DFT} ) ] , d [ mod ( {l}_{p} + L / 2 , {N}_{DFT} ) ] \} . \qquad ( 13 )$$

For the same data symbol, associated DFT/IDFT coefficients can be collected into a coefficient vector as

$${z}_{{l}_{p}} = \{ z [ mod ( {l}_{p} - L / 2 + 1 , {N}_{DFT} ) ] , z [ mod ( {l}_{p} - L / 2 + 2 , {N}_{DFT} ) ] … , z [ {l}_{p} ] , z [ mod ( {l}_{p} + L / 2 - 1 , {N}_{DFT} ) ] , z [ mod ( {l}_{p} + L / 2 , {N}_{DFT} ) ] \} \qquad ( 14 )$$

Then the lth sample of the distortion signal can be computed as

$$c [ l ] = {min}_{q ∈ Q} \vert r [ l ] + z [ l ] q \vert , \qquad ( 15 )$$

where Q denotes the set that contains quantization levels, and lth data symbol is one of the problematic symbols. The quantization level that leads to minimum peak value can be assigned to lth sample of the distortion signal 704. Due to random nature of the problem, it may not be possible to find an analytical solution. Since the computation of optimum distortion signal is quite challenging, an optimization routine can be used to obtain near-optimal signals.

According to an example embodiment, the at least one memory and the computer program code are further configured to, with the at least one processor, cause the radio device to compute the distortion signal by finding, for each marked symbol, a quantization level that reduces the corresponding peak value.

For example, the at least one memory and the computer program code may be further configured to, with the at least one processor, cause the radio device to compute the distortion signal by finding, for each marked symbol, a quantization level that minimizes the corresponding peak value.

This problem is a nonlinear optimization problem and numerical optimization approach can be an appropriate approach. In line with this, the radio device 100 can utilize a PAPR reduction procedure to numerically find the near-optimal distortion signals 704.

Accordingly, an iterative clipping and filtering (ICF)-like algorithm can be used where the time-domain clipping and frequency-domain filtering are realized in an iterative manner. However, frequency-domain processing phase is quite different than that of ICF. The clipping noise samples that overlap only with the problematic data symbols are kept and the rest is nulled. This way, distortion on top of the data symbols that do not cause any large peaks can be prevented. Also, the overlapping clipping noise samples can be quantized to the quantization levels configured to obtain the quantized distortion signals. This reference algorithm can be used to create a dataset, and the distortion signals that are generated by this algorithm can be used as the labels in the dataset.

According to an example embodiment, the at least one memory and the computer program code are further configured to, with the at least one processor, cause the radio device to find the quantization level for each marked symbol using a machine learning model.

The radio device 100 can implement a machine learning based PAPR reduction method to effectively reduce the peaks through a data symbol domain processing before the IFFT 713. This approach can generalize the peak detection procedure for different bandwidth and modulation configuration cases and exploit machine learning to reduce the peaks effectively.

According to an example embodiment, the machine learning model comprises a neural network or a decision-tree based algorithm.

The approach models the problem as a classification problem and is compatible with, for example, deep neural networks (DNNs) and different decision tree-based algorithms.

According to an example embodiment, the machine learning model is configured to take the symbol vector, the coefficient vector, and the peak value of the marked symbol as an input and output a part of the distortion signal corresponding to the marked symbol.

A goal of the PAPR reduction phase is to find a distortion signal that provides a near-optimal PAPR performance under the constraint of quantization levels that are in line with the EVM threshold. This can be expressed as

$$[ real ( {\hat{c}}_{{l}_{p}} ) , imag ( {\hat{c}}_{{l}_{p}} ) ] = {f}_{PAPR} ( real ( {d}_{{l}_{p}} ) , imag ( {d}_{{l}_{p}} ) , real ( {z}_{{l}_{p}} ) , imag ( {z}_{{l}_{p}} ) , real ( {r}_{{l}_{p}} ) , imag ( {r}_{{l}_{p}} ) ) , \qquad ( 16 )$$

where f_{PAPR}(.) represents the algorithm and ĉₗ_{ₚ}, denotes the distortion signal sample predicted by the algorithm.

According to an example embodiment, the at least one memory and the computer program code are further configured to, with the at least one processor, cause the radio device to obtain an EVM threshold, and compute the distortion signal based on the marked symbols and the EVM threshold.

According to an example embodiment, the at least one memory and the computer program code are further configured to, with the at least one processor, cause the radio device 100 to perform a discrete Fourier transform precoding 712 on the sum signal, producing a pre-coded signal 705, and perform an inverse discrete Fourier transform 713 on the pre-coded signal 705, producing a DFT-s-OFDM signal 706.

According to an example embodiment, the at least one memory and the computer program code are further configured to, with the at least one processor, cause the radio device to compute a plurality of peak-cancelation signals using guard-band tones based on the peak values, and apply the plurality of peak-cancelation signals to the pre-coded signal before performing the inverse discrete Fourier transform on the pre-coded signal.

The predicted ĉₗ_{ₚ}, can be added to the original plurality of symbols dₗ_{ₚ}, and this can then be processed instead of only dₗ_{ₚ}, to generate the PAPR reduced DFT-s-OFDM signal x̅ₙ.

The radio device may compute the plurality of peak-cancelation signals according to the GTR procedure. Thus, the radio device 100 can combine the peak detection and the PAPR reduction with the GTR to further improve the PAPR gain.

FIG. 9 illustrates a block diagram of a training procedure according to an example embodiment.

In training, random signals can be generated 801 and peak-detection 802 can be applied to the random signals. The inputs 803 required for the ML model, such as the random signals and information about detected peaks can be supplied to the model forward pass 805. These can also be provided to the utilized optimization algorithm 804 to generate the labels for the ML model. In the beginning of the training, random model parameters can be utilized 910 for the ML model.

As the result of the model forward pass 805, estimated distortion signals 806 can be obtained. At the end of each iteration, the loss can be computed 807 for the distortion signals estimated by the ML model by comparing them against the simulated distortion signals 808. Through forward and backward pass, the model parameters can be optimized using, for example, an Adam optimizer 809. This way, at the end of the iterative process, a trained ML model is obtained. The radio device 100 can utilise the trained ML model in the PAPR reduction.

In training, for example following binary cross-entropy loss function can be utilized for computing 807 the loss

$${ℒ}_{BCE} ( {c}_{{l}_{p}} , {\hat{c}}_{{l}_{p}} ) = - {\sum }_{{l}_{p}} c [ {l}_{p} ] log ( \hat{c} [ {l}_{p} ] ) + ( 1 - c [ {l}_{p} ] ) ( 1 - log ( \hat{c} [ {l}_{p} ] ) ) . \qquad ( 17 )$$

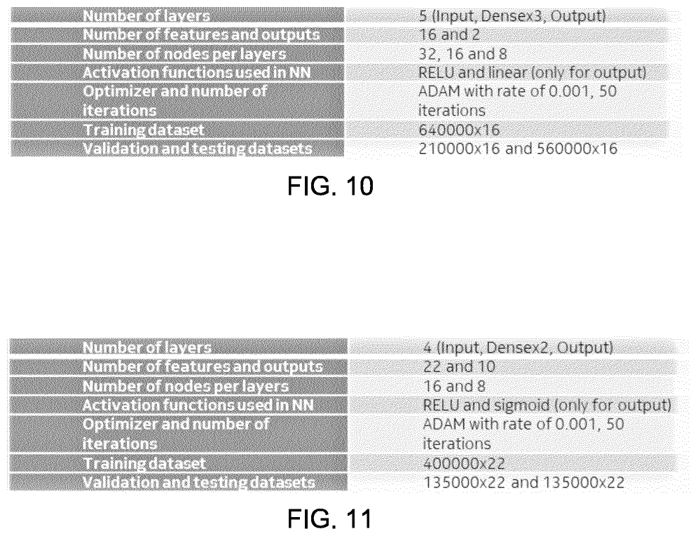

FIG. 10 illustrates parameters of a neural network configured for peak detection according to an example embodiment.

In the example embodiment of FIG. 10, the neural network configured for peak detection has one input layer, three dense layers and one output layer. The dense layers are configured to have 32, 16 and 8 nodes, respectively. In the training, an Adam optimizer was utilized with epoch value of 50. R² metric is evaluated for the regression performance of the trained network, and it provided R² scores up to 99% and 99% for both training and validation datasets.

FIG. 11 illustrates parameters of a neural network configured for PAPR reduction according to an example embodiment.

In the example embodiment of FIG. 11, neural network configured for PAPR reduction has one input layer, two dense layers and one output layer. The dense layers are configured to have 16 and 8 nodes, respectively. In the training, an Adam optimizer was utilized with epoch value of 50. Classification accuracy of the trained network was evaluated, and it provides an accuracy between 80% and 85% for both training and validation datasets.

In the following some numerical evaluations are presented by considering 20 MHz 5G NR bandwidth configuration, with a subcarrier spacing of 60 kHz and over-sampling factor of 4. In addition, clipping level of 5 dB is targeted with the algorithms, and for reference, an alternative peak-detection filter and GTR are also evaluated. Moreover, symbol group length is configured as L=5.

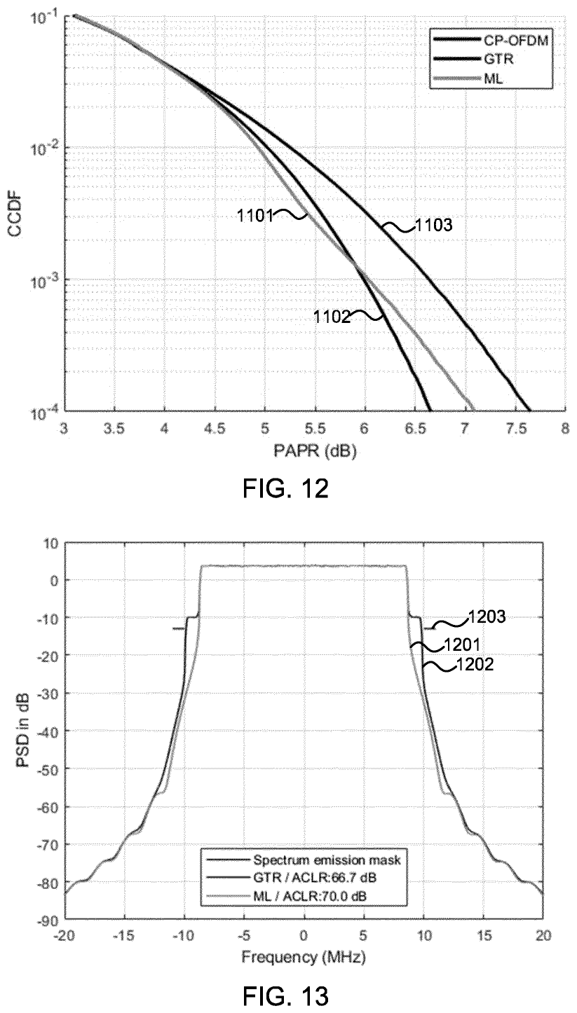

FIG. 12 illustrates simulation results according to an example embodiment.

The example embodiment of FIG. 12 illustrates complementary cumulative distribution function (CCDF) probability as a function of PAPR. Curve 1101 corresponds to a machine learning based solution of the radio device 100, curve 1102 corresponds to GTR, and curve 1103 corresponds to CP-OFDM.

FIG. 13 illustrates simulation results according to another example embodiment.

The example embodiment of FIG. 13 illustrates power spectral density (PSD) as a function of frequency to illustrate spectral containment performance. Curve 1201 corresponds to ML, curve 1202 corresponds to GTR, and curve 1203 corresponds to spectrum emission mask.

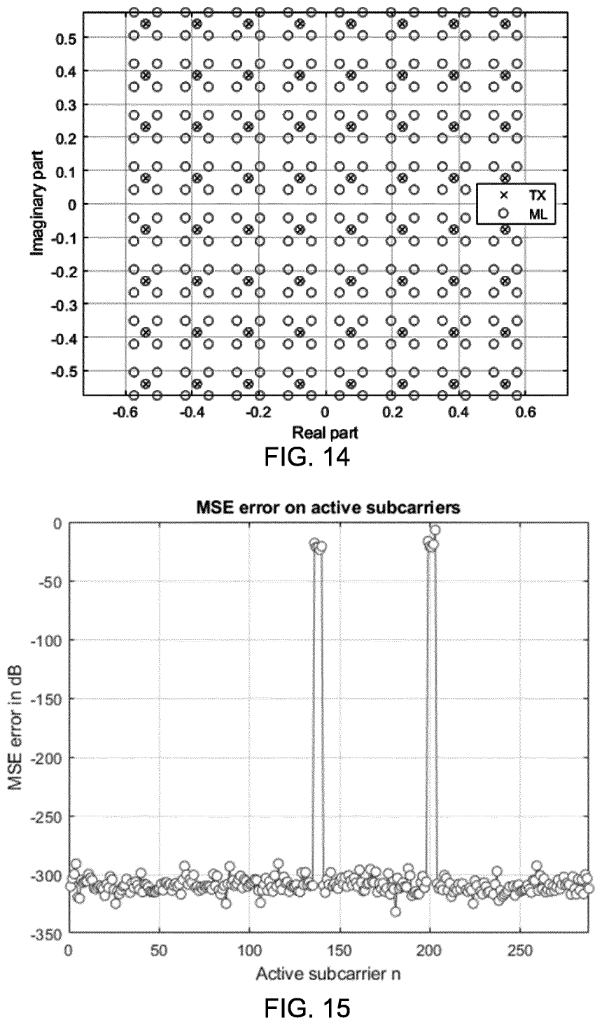

FIG. 14 illustrates constellation points for the quantized distortion signal samples according to an example embodiment.

In the example embodiment of FIG. 14, quantization mapping is visible where four different levels are available next to the original constellation points. Hence, some small increase in EVM can occur for problematic data symbols. FIG. 14 only illustrates problematic symbol groups collected from long simulations and there is no such degradation for the other data symbols.

FIG. 15 illustrates simulation results according to an example embodiment.

The example embodiment of FIG. 15 illustrates symbol-wise mean square error (MSE).

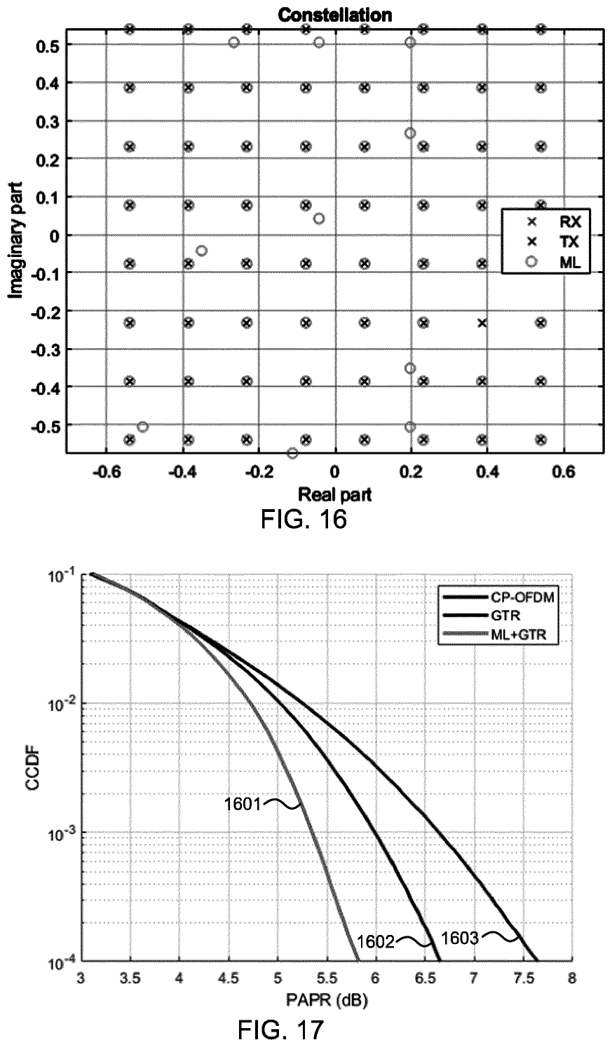

FIG. 16 illustrates possible quantization points according to an example embodiment. The example embodiment of FIG. 14 illustrates all the possible quantization points, and it does not represent the actual constellation points for single DFT-s-OFDM symbol with the proposed PAPR reduction procedure.

To clarify this, symbol-wise MSE values and constellation points are shown for an arbitrary case in the example embodiment of FIG. 15. As seen, in this example case, only ten data symbols out of 288 symbols are distorted using the quantization approach. And the MSE level is around −23 dB for these distorted symbols, corresponding to 6%-7% EVM, which is less than the 8% EVM limit defined for 64-QAM in 5G NR. Thus, the distortion level is in line with the EVM limit of 64-QAM.

Also, the constellation diagram of FIG. 16 illustrates only few quantization levels which again correspond to 10 data symbols, and most of them are outer constellation points. In some cases, inner constellation points are also distorted if these are part of the problematic symbols group. For the rest of the data symbols, since they are not distorted, they overlap with the original 64-QAM constellation points.

FIG. 17 illustrates simulation results according to an example embodiment.

The example embodiment of FIG. 15 illustrates CCDF probability as a function of PAPR. Curve 1601 corresponds to a machine learning based solution of the radio device 100 combined with GTR, curve 1602 corresponds to GTR alone, and curve 1603 corresponds to CP-OFDM.

Since the radio device 100 may not utilize the guard bands, it can also implement other procedures in addition to those disclosed above. For example, the radio device 100 can combine GTR with the peak detection and/or PAPR reduction procedures disclosed herein to further reduce the PAPR. This processing is quite straightforward, as GTR can be applied after the peak detection and/or PAPR reduction procedures to reduce the peaks further by utilizing the empty tones available in guard bands. This way, better peak-cancellation signals can be created in a relatively efficient way. The information about the peaks needed for GTR can be provided by the peak detection procedure disclosed herein.

The results for combining the peak detection and PAPR reduction procedures with GTR are illustrated in FIG. 17.

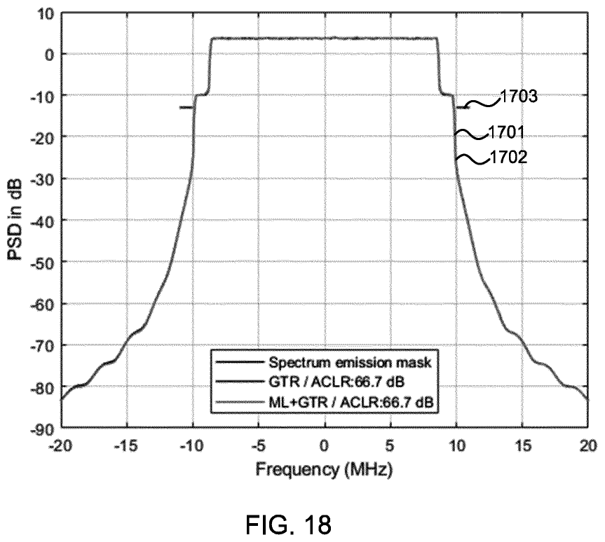

FIG. 18 illustrates simulation results according to another example embodiment.

The example embodiment of FIG. 18 illustrates PSD as a function of frequency to illustrate spectral containment performance. Curve 1701 corresponds to a machine learning based solution combined with GRT of the radio device 100, curve 1702 corresponds to GTR alone, and curve 1703 corresponds to spectrum emission mask. It is seen that the joint processing has more or less the same spectrum containment performance as GTR. This is expected as the proposed method does not degrade the guard bands, hence, joint processing should have the same ACLR performance as the GTR method.

Complexity analysis is quite challenging when a machine learning-based algorithm is compared against a conventional signal processing-based algorithm. Most of the conventional methods can be quantified in terms of real multiplications and additions. On the other hand, this is not the common approach for machine learning methods and time complexity is generally utilized in the machine learning literature. Time complexity of a neural network is more or less equal to multiplications occur between input, dense and output layers. On the other hand, FFT/IFFT operations mainly determine the complexity of DFT-s-OFDM processing.

For example, the neural network of the example embodiment of FIG. 11 comprises 22 input features, 2 dense layers with 16 and 8 nodes, and one output layer with 10 nodes. Similarly, oversampled FFT size of 2048is utilized the numerical analysis. Hence, the configured network leads to approximately 5% increase in complexity when nominal FFT size is considered and 25% increase in complexity when oversampled FFT is considered.

GTR can be used as a reference as the other methods are quite complex and GTR also can have a quite similar computational complexity performance. The complexity of the procedures performed by the radio device 100 can be improved further by utilizing, for example, accelerators or advanced architectures. This can be advantageous over GTR.

The cost of a single operation can be lower in ML hardware than on a conventional chip. Thus, it is very difficult to compare complexity in terms of operations. One should rather compare the power consumption on the final target hardware.

The NN architecture can learn the quantization mapping quite accurately and this can lead to quite good PAPR performance due to precisely predicted distortion signals. As shown, even better gains can be obtained if guard band tones or any other empty tones available in the channel bandwidth are utilized for generating the peak-cancellation signals.

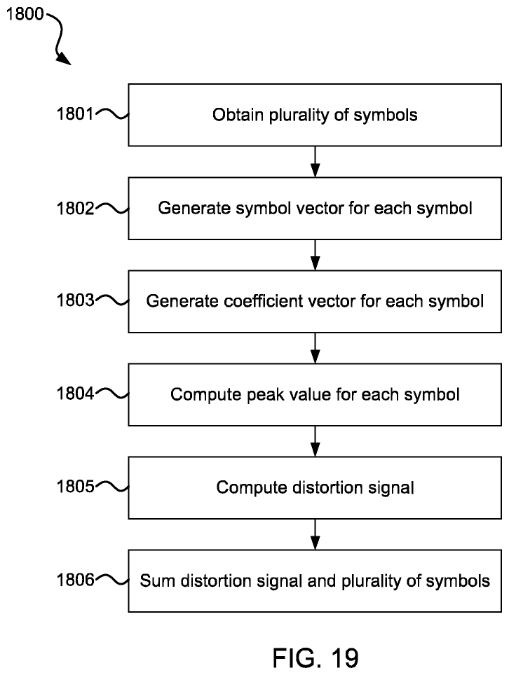

FIG. 19 illustrates a flow chart representation of a method according to an example embodiment.

According to an embodiment, a method 1800 comprises obtaining 1801 a plurality of symbols.

The method 1800 may further comprise generating 1802 a symbol vector for each symbol in the plurality of symbols comprising the symbol and at least symbols contiguous to the symbol in the plurality of symbols.

The method 1800 may further comprise producing 1803 a coefficient vector for each symbol in the plurality of symbols comprising corresponding Fourier coefficients of the symbol vector of the symbol.

The method 1800 may further comprise computing 1804 a peak value for each symbol in the plurality of symbols based on the symbol vector of the symbol and the coefficient vector of the symbol.

The method 1800 may further comprise computing 1805 a distortion signal based at least on the peak values.

The method 1800 may further comprise summing 1806 the distortion signal and the plurality of symbols, producing a sum signal.

An apparatus may comprise means for performing any aspect of the method(s) described herein. According to an example embodiment, the means comprise at least one processor, and memory comprising program code, the at least one processor, and program code configured to, when executed by the at least one processor, cause performance of any aspect of the method.

The functionality described herein can be performed, at least in part, by one or more computer program product components such as software components. According to an example embodiment, the radio device 100 comprises a processor configured by the program code when executed to execute the example embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and Graphics Processing Units (GPUS).

Any range or device value given herein may be extended or altered without losing the effect sought. Also any example embodiment may be combined with another example embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one example embodiment or may relate to several example embodiments. The example embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the example embodiments described above may be combined with aspects of any of the other example embodiments described to form further example embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various example embodiments have been described above with a certain degree of particularity, or with reference to one or more individual example embodiments, those skilled in the art could make numerous alterations to the disclosed example embodiments without departing from the spirit or scope of this specification.

In the following, an example embodiment of weights and biases for the neural network illustrated in the example embodiment of FIG. 10 are provided. b2-b5 are the biases for each layer and w2-w5 are the weights for each layer. b2-b5 are vectors and w2-w5 are matrices.

```
  b2=[−
0.03125,0.05053,0.04030,0.04832,0.01787,0.00665,0.0237
8,−0.01821,−0.03484,−0.00088,−0.03665,0.01570,−
0.01926,0.02157,−0.03590,−0.01949,−
0.03628,0.01841,0.01569,0.04682,0.02543,−0.03402,−
0.02006,0.01857,−0.02994,0.00601,−0.03170,0.01922,−
0.01973,0.02273,−0.02955,0.01469]
  b3=[0.00680,−0.00490,0.00893,−
0.01719,0.00041,−0.00770,−0.00883,−
0.00675,0.01096,0.01004,0.00437,−0.01045,−
0.00035,0.00452,0.02609,0.00145]
  b4=[−0.00514,−0.00637,0.00248,0.00052,−
0.00530,−0.00572,−0.00302,−0.00550]
  b5=[0.00000,0.00000,0.00000,0.00000,0.00000,0
.00000,0.00000,0.00000,0.00000,0.00000,4.9766*10\hat{ }−4
5.0153*10\hat{ }−4]
  w2=0.01952,0.02332,−0.03085,−0.04203,−
0.01496,−0.00443,0.03120,−0.00450,−0.03390,−
0.03163,0.03052,0.01128,0.02915,0.00623,−0.03092,−
0.03579,0.02128,−0.01669,0.05234,−0.00712,−0.03503,−
0.02276,−0.05798,0.03598,−0.01995,−0.00138,−0.00847,−
0.01932,0.00041,−0.01565,−0.07422,0.02637
  −0.02531,−0.01945,0.03550,0.08576,0.03420,−
0.01025,−0.08289,−0.06798,0.06758,0.06394,−0.00446,−
0.03885,−0.09610,−0.01363,0.15367,0.07289,−
0.04796,0.03409,−0.08750,0.04086,0.05474,−0.00312,−
0.01927,−0.10015,0.03262,0.03667,0.01338,0.03245,−
0.04426,0.07829,−0.05360,−0.08266
  0.05558,−0.05962,0.08551,−0.02540,−
0.12777,0.13405,−0.11338,0.09279,0.11849,−
0.04324,0.04375,0.11044,−0.00269,−0.14438,−
0.15725,0.01977,0.09503,0.01343,0.02003,0.09334,0.0991
3,−0.11137,−0.03300,0.07201,−0.07861,−0.02088,−
0.04446,−0.03572,−0.05287,−0.02895,−0.06087,0.03838
  0.02249,0.00963,−0.01511,−0.02912,−
0.07447,0.05312,0.04729,0.05403,−0.03815,−
0.01137,0.05487,0.04545,0.07935,−0.00868,−0.03448,−
0.02735,0.05432,0.00079,0.01821,−0.06308,−0.03755,−
0.08129,0.02544,0.11266,−0.05593,0.04119,−0.04051,−
0.03250,−0.03667,−0.04241,0.06428,0.06396
  −0.01422,−0.01466,0.01283,0.00203,0.01798,−
0.00844,−0.02177,−0.02988,0.01972,0.08376,−0.01584,−
0.01288,−0.01922,−0.00105,0.02321,0.03806,−0.02023,−
0.00417,−0.03149,0.01415,0.02372,0.03167,0.03853,−
0.03700,0.01760,−0.02163,−
0.00678,0.01428,0.03997,0.01418,−0.03264,−0.02205
  0.02620,0.00458,−0.02257,−
0.00670,0.02326,0.01618,0.02424,0.03778,−0.01038,−
0.02620,−0.02738,0.02732,−0.00475,0.01193,0.03439,−
0.03840,0.02425,−
0.02623,0.03369,0.03190,0.01598,0.02529,−
0.06742,0.04185,−
0.02765,0.00958,0.01221,0.01712,0.05406,−0.00699,−
0.00217,−0.02704
  −0.00834,0.01801,0.03797,−0.04217,−0.07109,−
0.03435,−0.06775,−0.00637,−0.00258,0.02575,0.05658,−
0.08698,−0.04279,−0.02484,−0.01979,0.03827,−
0.05914,0.03272,−0.10848,−0.09660,−0.04280,−
0.01284,0.02544,−0.11171,0.02345,0.02059,−0.03389,−
0.08821,0.05042,0.02034,−0.06049,0.06265
  0.10259,0.15102,−0.03902,0.03362,−0.10293,−
0.07971,0.11584,0.00362,0.07676,0.08205,−0.05484,−
0.11524,−0.00338,0.04658,−0.07628,0.03998,−0.09550,−
0.07428,0.02559,−0.01006,0.11622,0.01730,0.01013,−
0.06659,−0.04807,−0.09029,0.02733,−0.17900,−
0.08393,0.03263,0.03671,0.04719
  0.08154,0.03296,−0.03349,−
0.00021,0.05649,0.00365,0.04691,−0.00943,0.03106,−
0.10344,−0.04576,0.03025,−0.02814,0.00998,0.03613,−
0.07713,0.04178,−
0.03122,0.05248,0.06199,0.06717,0.07925,0.03458,0.0758
2,−0.02239,0.00571,−0.00042,0.02643,−
0.03580,0.01831,0.10014,−0.05657
  −0.04171,−0.00214,0.00071,−0.01170,−
0.00534,0.00977,−0.02026,0.04206,−
0.01723,0.03323,0.02950,−0.01525,−0.00038,−0.00764,−
0.02720,0.02760,−0.01502,0.00780,−0.01481,−0.04075,−
0.02664,−0.02880,0.00569,−0.03823,0.02289,−0.01071,−
0.01924,−0.01284,0.03604,0.00058,0.09470,0.02656
  0.07013,−0.11583,0.01272,−0.03407,0.00922,−
0.01987,−0.03384,−0.01558,0.06347,−0.02021,0.09251,−
0.00142,0.01165,−0.02874,−0.05445,−
0.12840,0.03605,0.01718,−0.02405,0.08158,0.03891,−
0.09142,−0.04211,−0.06215,−0.02768,0.05752,0.05056,−
0.07290,0.00579,−0.04450,0.07646,0.03102
  −
0.01740,0.07293,0.01872,0.06995,0.04996,0.08640,−
0.04068,0.03945,−0.06056,−0.08811,−0.01316,−0.07590,−
0.03133,0.00623,−0.05050,−0.04518,−0.00343,0.03152,−
0.04919,0.07854,0.05606,−0.04755,0.01315,−0.03506,−
0.08862,−0.06836,0.06218,0.06814,0.01023,0.08278,−
0.00065,−0.01975
  0.09258,0.04193,−0.06303,−0.04938,−
0.11525,0.01636,−0.05377,0.06347,−0.04489,0.03514,−
0.01919,0.04761,−
0.01373,0.02600,0.06053,0.00850,0.07392,−0.09246,−
0.01219,0.08384,0.05614,−0.01980,−0.09653,−0.08005,−
0.02471,−0.02673,−0.09510,−0.02144,−0.02060,0.01768,−
0.03794,0.13494
  0.03050,−0.06633,−0.00366,0.06910,−
0.02139,0.00573,0.07139,0.04508,0.03670,−0.03284,−
0.01163,0.00513,0.02372,−0.14741,0.00339,0.01690,−
0.08080,−0.02317,0.02151,−0.09026,0.07789,0.00725,−
0.10768,0.01235,−0.05489,0.06228,−0.02058,−
0.00900,0.06871,−0.02960,−0.03235,0.02882
  0.02005,0.06897,0.01732,−
0.01903,0.06835,0.00482,−0.01136,0.10656,−
0.06360,0.02239,−0.02979,−
0.04519,0.01004,0.07539,0.04832,0.01626,−
0.01335,0.03701,0.04961,−
0.01464,0.01208,0.04318,0.00089,−0.01172,−
0.06203,0.03955,−0.04764,0.02191,−0.02512,0.16946,−
0.03519,−0.04382
  −0.05941,0.02582,−0.01754,−
0.00411,0.00615,0.06144,−0.07978,−0.03933,−0.04837,−
0.05187,−0.00491,−0.04504,−
0.01548,0.01143,0.03248,0.01805,0.01474,−
0.02628,0.11233,−0.08886,−0.03960,−0.05164,−0.04073,−
0.00705,0.12830,−0.03009,−0.12927,0.02489,0.09297,−
0.05415,−0.02759,−0.04386
  −0.03083,−0.03725,−0.08636,−0.05590,−
0.08283,0.06403,0.06190,−0.00441,0.09214,0.15425,−
0.01541,−0.03278,0.04263,0.04635,0.03357,−
0.02423,0.05815,−0.05591,0.06964,0.02338,0.00824,−
0.02068,0.08741,−0.00883,−0.02731,0.02691,0.00824,−
0.06898,0.05049,0.03371,0.07129,0.00633
  0.01107,−0.05848,0.03112,0.00232,−
0.00367,0.01239,−0.02666,−0.01042,−
0.00709,0.05688,0.00486,−0.05229,−0.07676,−0.03893,−
0.07385,−0.05556,−0.00318,0.04853,−0.06030,−0.07606,−
0.05813,0.07100,0.03861,−0.04345,−0.01538,0.08040,−
0.00361,0.02068,0.05474,0.02701,0.02799,0.02099
  −0.02239,−0.09015,−0.04150,−0.00005,−
0.07592,−0.04139,−0.03447,−0.04789,0.03426,−0.01880,−
0.01523,0.00961,−0.03952,0.07418,0.02454,0.07544,−
0.01287,0.02727,−0.07829,−
0.09873,0.08701,0.07643,0.01903,−0.03545,−
0.05516,0.04127,0.02875,0.00648,−0.01306,−0.00819,−
0.03766,−0.00627
  −0.01737,0.07662,−0.09622,0.00764,−
0.06233,0.08378,−0.00192,0.02730,−0.04248,−0.00731,−
0.02023,−0.08848,0.03406,0.00413,−
0.08883,0.02614,0.17593,0.05515,−0.03218,0.05625,−
0.06502,−0.13787,−0.03597,0.07174,−0.01066,−
0.00086,0.12727,−0.07885,−
0.12543,0.02069,0.00053,0.05218
  0.09144,−0.02631,0.05634,−
0.00279,0.04973,0.07569,0.01100,−0.00018,−0.03518,−
0.01626,0.00064,0.00572,−0.03755,0.03101,−
0.00122,0.00147,−
0.01290,0.07019,0.02691,0.04995,0.08539,−
0.01545,0.02041,−0.11573,−
0.00535,0.03782,0.02072,0.05260,0.00480,0.06956,−
0.04039,0.15976
  −0.00252,−0.01701,0.06926,−0.05493,−
0.02732,0.00422,0.00896,−0.01291,0.02500,0.03348,−
0.00923,0.00455,0.05849,0.01028,−0.05092,−
0.02652,0.04714,0.01716,−
0.05321,0.01582,0.05023,0.02079,0.08782,0.03105,0.0143
9,0.02025,0.01485,0.01960,−0.08147,0.01247,−0.03580,−
0.01029
  w3=−0.02594,−0.04733,−0.13072,−0.02753,−
0.08431,0.13058,0.03941,−0.03784,0.08570,−
0.01940,0.01250,−0.03858,0.00205,−0.02188,0.00663,−
0.03006
  −0.09055,0.06901,0.01145,−
0.03700,0.06977,0.04651,0.05172,−0.03601,−0.05470,−
0.00723,−
0.09455,0.01321,0.06261,0.05713,0.02130,0.03702
  0.09316,−0.01427,−0.00751,−0.01532,0.01672,−
0.08316,−0.01858,−0.04374,0.03501,0.02310,0.01213,−
0.04374,−0.02253,0.03116,−0.01812,0.04912
  −0.00110,0.04134,−0.02832,0.03108,0.00199,−
0.05741,0.03053,0.03726,−0.05767,0.04574,−
0.01879,0.06636,−0.02285,0.02856,0.04682,−0.05510
  0.08385,−0.03697,−0.04931,−0.02161,−0.05651,−
0.04400,−0.00365,−0.01370,−0.14186,−0.08783,0.00062,−
0.03402,0.05038,0.00047,−0.01950,0.03686
  −0.01267,−0.04035,−0.05343,0.00569,−0.08259,−
0.02342,0.07167,−0.02349,0.03401,0.00431,0.00593,−
0.05254,−0.04159,0.07830,0.06673,−0.09399
  −0.02457,0.04804,0.07435,0.05990,−0.01967,−
0.00484,0.05188,0.00816,−0.00503,0.04351,−0.06189,−
0.06713,−0.00729,0.01467,−0.10193,0.07282
  0.02814,−
0.02153,0.05129,0.06557,0.00465,0.01826,−0.04278,−
0.00679,0.01006,0.06646,−0.01384,−0.01847,−0.02970,−
0.03331,0.01098,−0.00343
  −0.09961,−0.00039,−0.00624,0.00438,−
0.13983,0.03485,−0.10359,0.04534,0.02250,−0.01155,−
0.02987,0.00508,−0.01728,−0.03465,0.02861,−0.01033
  0.02000,−0.07929,0.00447,−0.01001,−
0.01949,0.00780,−0.01344,−0.11916,−0.02499,0.01263,−
0.03184,−0.00645,0.07095,−0.02059,0.06108,−0.01266
  0.07566,0.06741,−0.02964,−0.00985,0.01063,−
0.02478,0.02277,−0.05157,−0.00024,0.04013,−0.00973,−
0.07020,0.05816,0.00203,0.04940,−0.03791
  −0.05620,0.00365,−0.13434,−0.06283,−0.02848,−
0.04184,−0.05191,−0.00995,−
0.08301,0.05746,0.05404,0.01177,0.06231,0.00710,−
0.06468,0.01541
  −0.03110,0.01835,0.02337,−0.09034,−
0.02931,0.02600,−0.04743,0.03843,0.00866,0.02830,−
0.01766,−0.05700,0.01817,−0.04094,−0.02191,−0.02034
  0.04808,−0.03872,0.05417,0.01831,−0.04174,−
0.01293,0.04529,−0.03794,−0.03454,−0.05657,−0.08816,−
0.03535,−0.06048,−0.07976,−0.06187,−0.03338
  −0.00190,0.04183,0.07329,−0.02193,−
0.02770,0.07291,0.00303,0.01795,−0.00846,0.02040,−
0.04884,−0.07023,0.00433,−0.04817,0.03176,−0.07539
  −0.02748,−
0.04725,0.03402,0.00834,0.06031,0.00452,0.01196,−
0.01926,0.08055,0.08558,0.01350,0.01917,−
0.01640,0.07978,−0.06779,0.03239
  −0.13677,0.00184,0.06117,−0.04169,−
0.02034,0.02945,0.07606,0.00741,−0.02448,−0.10664,−
0.07660,0.03807,−0.00496,0.02135,−0.08731,0.06968
  −0.01982,−0.04088,−0.00123,0.00691,0.02056,−
0.02923,0.02905,−0.10252,0.02994,−0.03295,−0.05312,−
0.05950,0.03335,0.01929,−0.04447,−0.04428
  0.03273,0.04049,−0.03028,0.01429,−
0.03013,0.00024,0.00423,0.01182,0.03230,0.04320,−
0.01483,−0.00870,0.05306,0.05862,0.04788,−0.03609
  −0.03266,−0.03511,0.02355,0.04254,0.00086,−
0.02194,0.08829,0.06727,−0.01842,−0.04504,0.04823,−
0.03374,−0.00198,−0.04044,−0.04313,−0.01980
  −0.13876,−0.00826,0.01574,−
0.01627,0.11242,0.02649,0.07903,−
0.03651,0.00665,0.00612,0.03670,−0.00721,0.04531,−
0.01580,−0.01968,−0.15273
  −0.04455,0.01926,0.08892,−0.00628,−0.04776,−
0.04111,0.04532,−0.04180,−0.02006,0.02732,0.02153,−
0.02029,−0.08623,−0.05170,−0.05157,−0.04592
  −0.03936,−0.00011,0.00084,0.07675,−0.00246,−
0.01551,0.00084,−0.02095,−0.05465,0.01036,−
0.01932,0.00253,−0.13243,0.05994,0.00698,−0.02038
  0.13394,0.07509,−
0.09837,0.05170,0.08949,0.03005,−0.00977,−
0.11485,0.09031,−0.04135,0.01970,0.07359,0.07034,−
0.01721,−0.00928,0.00097
  0.10599,−0.06814,0.01747,0.04859,−
0.04967,0.03378,0.05252,−0.00338,0.01027,0.01017,−
0.01847,0.09374,−0.10103,0.02227,0.03219,0.07142
  −0.03770,−0.04792,−0.01042,0.03076,−0.10444,−
0.00959,−0.08761,−0.10701,−0.01629,0.03915,0.03860,−
0.00474,−0.04218,−0.01452,−0.00509,0.02085
  0.01293,−0.03591,0.00694,0.01471,−0.02173,−
0.08058,0.07548,−0.07412,0.00097,0.06940,−
0.00543,0.09157,−0.00947,−0.01514,−0.06772,0.03344
  −0.06514,−0.06160,−0.04113,−0.06364,0.00053,−
0.01182,−0.03744,−0.00791,−
0.13859,0.03464,0.05002,0.03264,0.07270,−
0.04386,0.01148,0.06173
  0.00213,0.00151,−0.00021,0.12902,−
0.02826,0.03818,0.04432,0.00377,0.02437,−
0.04245,0.04418,−0.04082,−0.04830,−0.00740,−
0.09295,0.01573
  −0.04687,−0.03945,0.00575,0.01941,0.02077,−
0.05133,−0.04395,−0.01925,0.04491,0.01687,0.03900,−
0.02259,0.04595,−0.00864,−0.02130,0.01525
  −0.01439,0.02239,−0.01593,−0.03902,−0.00626,−
0.00789,0.03947,−0.05780,0.00625,0.03066,0.01010,−
0.03499,0.02332,0.01647,−0.00722,0.02997
  −0.02693,−0.04233,−0.00877,−0.05559,−
0.05345,−0.01625,0.08552,0.00007,−0.01938,−
0.07303,0.08773,−0.06470,−0.04821,0.06198,0.00066,−
0.00344
  w4=−0.00002,−0.04922,−0.19201,−
0.03673,0.06011,−0.01056,−0.05400,0.01149
  0.06770,−0.01345,0.01009,0.04762,0.04814,−
0.11398,−0.03835,−0.06713
  −0.08981,−0.00248,0.02310,−0.04087,−0.02161,−
0.03310,0.00777,0.05709
  0.07958,0.04913,−0.00470,−0.03515,−
0.01641,0.02888,0.03499,0.02708
  −
0.00155,0.01088,0.05132,0.06338,0.03567,0.08002,0.0361
2,−0.05547
  0.03451,−0.00513,−0.06663,0.01719,−0.00424,−
0.01302,−0.07995,0.07832
  0.07981,−0.02494,0.02399,−0.02510,0.00979,−
0.05884,−0.04701,−0.01562
  0.03596,0.01812,0.08257,−0.02547,−
0.06505,0.09862,−0.00412,0.04697
  −0.03188,0.04633,0.10087,0.02276,−0.01340,−
0.05334,−0.07112,−0.04263
  −0.02342,−0.02738,−0.03424,−
0.00634,0.04200,0.06666,0.03974,−0.03507
  0.02490,−0.02072,−0.04540,0.06343,−0.14509,−
0.02534,−0.07123,−0.00029
  −0.05531,−0.01402,0.02355,−
0.10190,0.07642,0.04414,−0.02857,0.00554
  −0.05820,−0.07358,−0.01438,−0.00172,−
0.09804,−0.00231,−0.01720,−0.04696
  0.04788,0.01805,0.01205,0.01666,−0.08386,−
0.00180,0.03858,−0.07105
  −0.05910,−0.00548,0.02236,0.03341,−0.03125,−
0.02762,−0.03163,0.00067
  0.08161,−0.06718,−0.00974,−0.13370,−
0.00621,0.05460,−0.04597,−0.00498
  w5=−0.49477,0.29281,0.43160,0.53633,−
0.02525,0.18235,0.19634,0.07782,−0.21612,−0.18778,−
0.28289,−0.40162
  0.07603,0.40380,0.00372,0.29448,0.11939,−
0.03508,0.41903,0.06025,0.03332,−
0.40424,0.49567,0.04090
  −0.00453,−0.15234,0.16085,0.16127,−
0.05087,0.14743,−0.34901,0.00492,0.05511,−0.00143,−
0.00013,−0.26981
  0.34638,−0.02828,−0.53705,−0.08645,−
0.11347,0.05434,0.51647,0.33745,0.43723,−0.24178,−
0.43710,0.13042
  0.47068,0.41020,0.50439,0.41699,−
0.29601,0.30724,0.30011,0.44319,0.28019,−
0.48397,0.48837,0.01244
  −0.23555,0.44638,−
0.22737,0.50962,0.32185,0.38497,−
0.30677,0.11671,0.15138,0.39887,−0.52240,−0.50656
  −0.05547,−0.31130,−0.30205,0.23246,−0.38345,−
0.17728,−0.06082,−0.11471,−0.50083,−0.48381,−
0.04292,0.01849
  0.43764,0.49648,−0.06339,−0.25217,−0.51484,−
0.16643,−0.16715,−0.13440,−0.12099,0.01648,−0.42562,−
0.27434
```

In the following, an example embodiment of weights and biases for the neural network illustrated in the example embodiment of FIG. 11 are provided. b2-b4 are the biases for each layer and w2-w4 are the weights for each layer. b2-b4 are vectors and w2-w4 are matrices.

```
  b2=
[0.29900,0.54260,0.40349,0.46362,0.34053,0.52036,0.797
75,0.56954,0.39953,0.56247,0.35930,0.27508,0.27165,0.5
5753,0.22521,0.29208]
  b3=[0.05878,−0.04327,0.02868,−0.29783,−
0.00348,−0.12761,0.15060,−0.01401]
  b4=[−0.04411,−0.21380,−1.79465,0.13217,−
0.34761,0.16679,0.08412,1.32417,−0.71879,1.02189]
  w2=0.32382,0.58948,−0.33396,−
0.24801,0.27025,−0.31957,0.09306,0.04874,−
0.34627,0.06891,−0.22890,−
0.53387,0.18325,0.27301,0.25814,0.22832
  −0.82048,−1.11001,0.53931,0.80901,−
0.40956,0.64472,−0.13681,−
0.35638,0.26593,0.03056,0.59087,0.63083,−0.33572,−
0.84937,−0.36104,−0.72713
  −1.15535,0.59102,−
1.44570,0.38283,0.72417,1.84990,−0.24392,0.65348,−
1.49671,1.51967,1.12287,0.86275,1.00815,−
0.63345,0.38962,−0.47928
  0.07055,0.30168,−0.80154,−0.11306,0.27404,−
0.57999,−0.42077,0.46680,−0.33818,0.81537,−
0.34361,0.75743,0.50645,0.17525,1.15667,0.68939
  −0.02691,−0.23077,0.30176,0.23883,−
0.14683,0.38414,0.29395,−0.18370,−0.03134,−
0.24322,0.24912,−0.53763,−0.21568,−0.08682,−0.42506,−
0.59107
  0.44119,−
0.34633,0.22548,0.46899,0.21825,0.24284,0.12930,0.1859
2,−0.51138,−0.23399,−0.20356,−
0.29832,0.30277,0.01114,0.14703,−0.14809
  −0.51984,0.63428,−0.83804,−0.76115,−0.33903,−
0.14917,0.03544,0.09061,0.84204,0.90014,0.40970,0.2339
2,−0.65664,0.38256,−0.59774,0.38576
  1.34364,−0.25388,−1.44180,1.42817,−
0.78267,1.22743,−0.23538,0.80380,0.55509,1.58081,−
0.94663,−0.29552,−0.78428,0.93767,−1.08758,−0.38746
  0.62986,−
0.51978,0.72359,0.47687,0.04337,1.04348,−
0.87621,0.54319,−0.04135,−0.45088,−
0.73044,0.37697,0.49243,0.21670,0.56968,−0.58175
  −0.05515,0.13889,−0.34988,−0.17616,−0.01721,−
0.33082,0.69062,0.00527,0.00088,0.31951,0.36485,−
0.30093,−0.14965,−0.00365,−0.34628,0.33191
  −8.46116,4.45864,1.80879,3.38284,−12.20489,−
0.79636,3.44601,−
8.31058,1.50487,0.79061,1.43195,3.28461,5.96912,10.829
83,7.18126,−7.74705
  7.78299,−4.08190,−1.50722,−
2.95249,11.46311,1.04167,−3.10461,7.77742,−1.13774,−
0.80434,−0.58149,−2.72283,−5.45684,−10.16308,−
6.72266,7.68078
  0.00498,0.41768,−
0.00836,0.32484,0.09281,0.22037,0.92244,0.42695,−
0.57511,0.38787,−0.77196,0.00571,−0.17585,0.38180,−
0.37900,−0.92334
  −9.48789,5.53135,2.22900,4.12722,−12.79431,−
0.38600,4.17752,−
9.90025,2.84447,1.10952,3.08417,4.48715,6.67687,11.710
45,8.44598,−7.49855
  9.56976,−5.42212,−2.24421,−
4.01567,12.81524,0.61707,−4.02415,9.51254,−2.34706,−
0.80365,−2.54586,−4.22662,−6.56751,−11.76195,−
8.12059,7.69852
  4.11273,−1.91222,−0.95651,−
1.52951,6.53688,0.27781,−1.41576,4.27877,−1.06193,−
0.46262,−1.30681,−1.41227,−2.86759,−5.89623,−
3.64006,2.05439
  −4.16727,1.92018,0.96265,1.58061,−6.47358,−
0.18075,1.29331,−
4.32415,1.07244,0.54721,1.28221,1.36800,2.75043,5.8337
3,3.55334,−2.09531
  4.03934,−1.96708,−0.84674,−
1.42002,6.55415,0.22876,−1.25611,4.32127,−1.08256,−
0.31657,−1.21710,−1.39709,−2.76204,−5.74867,−
3.58428,2.13815
  −4.11871,1.91760,0.96490,1.49452,−6.61393,−
0.16988,1.34922,−
4.45029,1.06813,0.42856,1.30726,1.45624,2.91996,5.8923
3,3.52860,−1.92338
  4.07914,−1.87090,−0.88202,−
1.61296,6.45181,0.26043,−1.29489,4.39088,−1.09184,−
0.46525,−1.24870,−1.37212,−2.83260,−5.82938,−
3.58310,2.06055
  −3.68444,1.32645,−
9.98730,1.70496,3.94478,5.81370,−
5.87091,2.89496,0.90976,−
2.37906,4.29371,4.05647,3.78766,−4.14937,1.76779,−
2.44081
  4.40391,0.79476,−2.18287,5.08507,−
3.62820,4.34812,−3.47596,2.37952,2.62615,5.60575,−
6.39673,−3.64736,−3.93572,−0.81548,−5.11840,3.65956
  w3=−0.42967,−
0.87453,0.96514,0.90530,0.27766,1.07272,0.99981,−
0.04019
  −0.97696,−0.95311,0.33729,0.95575,0.55130,−
0.53185,0.02829,−0.01689
  −0.36385,0.63398,0.49461,−
2.45921,0.46341,0.22699,0.74909,−0.05427
  −0.69520,0.95798,−
1.28673,0.51359,0.81042,0.16315,0.30848,−0.03705
  1.21660,0.41548,−0.78236,−1.08060,−
1.75417,1.19677,−0.33432,−0.03112
  0.55338,0.28672,−2.01242,−0.11327,−
0.21695,0.55614,0.25871,0.03655
  −1.09776,−
0.06698,0.47414,0.34965,0.90122,0.66378,−0.47523,−
0.04348
  0.59601,−0.07783,0.59904,0.66064,1.13078,−
1.11785,−0.47205,−0.05045
  0.91306,0.69745,0.66911,0.80597,0.53008,−
0.78150,0.92189,0.00167
  0.78038,−1.90141,0.46150,0.28808,−
0.10802,0.88950,0.59957,−0.02682
  0.54938,1.06099,0.67178,0.46525,0.56531,−
0.63024,−2.86864,−0.06221
  −0.39950,0.44294,0.02563,−0.50721,−1.21138,−
0.57542,0.49607,−0.08568
  −1.04205,−0.29463,0.31959,0.76434,−
1.20259,0.43376,0.32231,−0.04514
  −1.20803,1.43265,−0.54007,−
0.89736,0.11987,0.80836,0.37680,−0.05682
  −2.97581,0.59752,0.81262,0.63443,−
0.97974,0.29021,0.58825,0.04841
  1.07544,0.25043,0.58947,0.32196,0.27730,0.397
35,1.30344,−0.01463
  w4=1.51306,−1.83171,−0.50473,1.24674,−
0.87416,1.22438,−1.52621,−1.33521,0.90173,−0.71116
  1.23059,−1.52516,−0.87770,0.98030,−0.67006,−
0.32146,0.48042,0.95060,−0.63517,0.46661
  −0.70736,0.97250,1.20445,−
0.82993,0.66695,0.80812,−1.03812,1.79257,1.15016,−
0.87437
  −0.00224,0.03124,−2.53246,−
0.54643,0.44414,0.72923,−0.97014,−0.82266,0.65148,−
0.51908
  0.54659,−0.77331,1.42700,1.21904,−
0.96582,0.55406,−0.81192,−1.20766,1.13061,−0.90646
  −0.65683,0.71672,−0.01491,0.06182,−0.12376,−
1.45079,1.67498,0.34064,−0.55903,0.24594
  −0.25019,0.46770,1.01955,−0.84255,0.73649,−
0.20063,0.35233,−1.21263,−0.95209,0.75921
  0.34179,−0.51076,0.02511,−0.37840,−0.22605,−
0.10112,0.25907,0.47580,−0.26822,0.49244
```

1. A radio device, comprising:
at least one processor; and
at least one memory including computer program code;
the at least one memory and the computer program code configured to, with the at least one processor, cause the radio device to:
obtain a plurality of symbols;
generate a symbol vector for each symbol in the plurality of symbols comprising the symbol and at least symbols contiguous to the symbol in the plurality of symbols;
generate a coefficient vector for each symbol in the plurality of symbols comprising corresponding Fourier coefficients of the symbol vector of the symbol;
compute a peak value for each symbol in the plurality of symbols based on the symbol vector of the symbol and the coefficient vector of the symbol;
compute a distortion signal based at least on the peak values; and
sum the distortion signal and the plurality of symbols, producing a sum signal.

2. The radio device according to claim 1, wherein the at least one memory and the computer program code are further configured to, with the at least one processor, cause the radio device to compute the distortion signal based at least on the peak values by performing:
compare a magnitude of each peak value to a threshold peak-to-average power ratio value, and in response to the peak value exceeding the threshold peak-to-average power ratio value, mark the corresponding symbol; and
compute the distortion signal based on the marked symbols.

3. The radio device according to claim 1, wherein the at least one memory and the computer program code are further configured to, with the at least one processor, cause the radio device to:
perform a discrete Fourier transform precoding on the sum signal, producing a pre-coded signal; and
perform an inverse discrete Fourier transform on the pre-coded signal, producing a discrete Fourier transform spread orthogonal frequency-division multiplexing signal.

4. The radio device according to claim 3, wherein the at least one memory and the computer program code are further configured to, with the at least one processor, cause the radio device to:
compute a plurality of peak-cancelation signals using guard-band tones based on the peak values; and
apply the plurality of peak-cancelation signals to the pre-coded signal before performing the in-verse discrete Fourier transform on the pre-coded signal.

5. The radio device according to claim 4, wherein the at least one memory and the computer program code are further configured to, with the at least one processor, cause the radio device to compute the peak value for each symbol in the plurality of symbols based on the symbol vector of the symbol and the coefficient vector of the symbol by performing:
compute the peak value for each symbol as a dot product between the symbol vector of the symbol and the coefficient vector of the symbol; or compute the peak value for each symbol using a neural network by inputting the symbol vector of the symbol and the coefficient vector of the symbol into the neural network and obtaining the peak value as an output of the neural network.

6. The radio device according to claim 5, wherein the neural network is configured to take a real part and an imaginary part of the symbol vector as separate inputs and a real part and an imaginary part the coefficient vector as separate inputs and output a real part and an imaginary part of the peak value as separate outputs.

7. The radio device according to claim 2, wherein the at least one memory and the computer program code are further configured to, with the at least one processor, cause the radio device to compute the distortion signal by finding, for each marked symbol, a quantization level that reduces the corresponding peak value.

8. The radio device according to claim 7, wherein the at least one memory and the computer program code are further configured to, with the at least one processor, cause the radio device to find the quantization level for each marked symbol using a machine learning model.

9. The radio device according to claim 8, wherein the machine learning model comprises a neural network or a decision-tree based algorithm.

10. The radio device according to claim 8, wherein the machine learning model is configured to take the symbol vector, the coefficient vector, and the peak value of the marked symbol as an input and output a part of the distortion signal corresponding to the marked symbol.

11. The radio device according to claim 10, wherein the at least one memory and the computer program code are further configured to, with the at least one processor, cause the radio device to:
obtain an error vector magnitude threshold; and
compute the distortion signal based on the marked symbols and the error vector magnitude threshold.

12. A client device comprising the radio device according to claim 1.

13. A network node device comprising the radio device according to claim 1.

14. A method comprising:
obtaining a plurality of symbols;
generating a symbol vector for each symbol in the plurality of symbols comprising the symbol and at least symbols contiguous to the symbol in the plurality of symbols;
generating a coefficient vector for each symbol in the plurality of symbols comprising corresponding Fourier coefficients of the symbol vector of the symbol;
computing a peak value for each symbol in the plurality of symbols based on the symbol vector of the symbol and the coefficient vector of the symbol;
computing a distortion signal based at least on the peak values; and
summing the distortion signal and the plurality of symbols, producing a sum signal.

15. A computer program product comprising program code configured to perform the method according to claim 14, when the computer program product is executed on a computer.
